(19) United States
(12) Patent Application Publication
(10) Pub. No.: US 2024/0227209 A1
(43) Pub. Date: Jul. 11, 2024

(54) Vacuum System End Effector

(71) Applicant: The Boeing Company, Chicago, IL (US)

(72) Inventors: Paul Flores, Charleston, SC (US); Luis Velasquez, Charleston, SC (US)

(21) Appl. No.: 18/150,690

(22) Filed: Jan. 5, 2023

(51) Int. Cl. B25J 15/06

(52) U.S. Cl. CPC B25J 15/0616; B64F 5/10

(57) ABSTRACT

A vacuum system end effector and methods of use are presented. A method of picking and placing an object applies a negative pressure to a first chamber of a base of a vacuum system end effector. The negative pressure is supplied from the first chamber to a first region of a manifold to lift the object while venting a second chamber of the base to atmosphere. A barrier is moved away from an opening in the first chamber to supply negative pressure from the first chamber of the base to the second chamber of the base. A number of vents through the second chamber is blocked to cease venting to atmosphere. The negative pressure is supplied from the second chamber to a second region of the manifold to compress the object.

### BACKGROUND INFORMATION

### 1. Field:

The present disclosure relates generally to the field of assembly, and in particular, to a vacuum system end effector for the placement and compaction of objects.

### 2. Background:

A preform for a composite part may be incapable of supporting itself when placed onto a sloped surface of a tool. In particular, placement of large preforms onto rigid tooling that exhibits a complex curvature can be complicated. This is because large preforms have an increased chance of peeling or shifting from tooling during or after placement. If the preforms are not quickly and firmly compacted onto tool, then peeling may occur. Thus, it remains desirable to quickly and effectively move and secure preforms (and/or other objects) to complex surfaces.

Therefore, it would be desirable to have a method and apparatus that takes into account at least some of the issues discussed above, as well as other possible issues.

### SUMMARY

An embodiment of the present disclosure provides a vacuum system end effector. The vacuum system end effector comprises a first region of a manifold configured to pick up an object; a second region of the manifold larger than the first region and configured to compress the object; a base; and a blocker door. The base comprises a first chamber configured to apply negative pressure to the first region and a second chamber configured to apply negative pressure to the second region, the second chamber comprising a number of vents to atmosphere. The blocker door is configured to actuate to supply or block a supply of negative pressure to the second chamber.

Another embodiment of the present disclosure provides a vacuum system end effector. The vacuum system end effector comprises a base configured to control negative pressure supplied to a first region of a manifold and a second region of the manifold, and a barrier within the base configured to actuate between blocking the opening or blocking the vent. The base comprises a first chamber having first stage passages to the first region of the manifold; a second chamber having second stage passages to the second region of the manifold; an opening through the first chamber configured to supply negative pressure to the second chamber; and a vent through the second chamber to atmosphere.

Yet another embodiment of the present disclosure provides a method of picking and placing an object. A vacuum is applied to a first chamber of a base of a vacuum system end effector. The vacuum is supplied from the first chamber to a first region of a manifold to lift the object while venting a second chamber of the base to atmosphere. A barrier is moved away from an opening in the first chamber to supply vacuum from the first chamber of the base to the second chamber of the base. A number of vents through the second chamber is blocked to cease venting to atmosphere. The vacuum is supplied from the second chamber to a second region of the manifold to compress the object.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of an aircraft in accordance with an illustrative embodiment;

FIG. 2 is an illustration of a block diagram of a manufacturing environment in accordance with an illustrative embodiment;

FIG. 3 is an illustration of an isometric view of a base of a vacuum system end effector in accordance with an illustrative embodiment;

FIG. 4 is an illustration of a portion of a vacuum system end effector in a lifting position in accordance with an illustrative embodiment;

FIG. 5 is an illustration of a portion of a vacuum system end effector in a compacting position in accordance with an illustrative embodiment;

FIG. 6 is an illustration of an isometric view of a vacuum system end effector in accordance with an illustrative embodiment;

FIG. 7 is an illustration of a bottom view of a vacuum system end effector in accordance with an illustrative embodiment;

FIG. 8 is a flowchart of method of picking and placing an object in accordance with an illustrative embodiment;

FIG. 9 is an illustration of an aircraft manufacturing and service method in a form of a block diagram in accordance with an illustrative embodiment ; and

FIG. 10 is an illustration of an aircraft in a form of a block diagram in which an illustrative embodiment may be implemented.

### DETAILED DESCRIPTION

The illustrative examples recognize and take into account one or more different considerations. For example, the illustrative examples recognize and take into account that composite parts, such as Carbon Fiber Reinforced Polymer (CFRP) parts, are initially laid-up in multiple layers that together are referred to as a preform. The illustrative examples recognize and take into account that individual fibers within each layer of the preform are aligned parallel with each other, but different layers exhibit different fiber orientations in order to increase the strength of the resulting composite part along different dimensions. The illustrative examples recognize and take into account that the preform includes a viscous resin that solidifies in order to harden the preform into a composite part (e.g., for use in an aircraft). The illustrative examples recognize and take into account that carbon fiber that has been impregnated with an uncured thermoset resin or a thermoplastic resin is referred to as “prepreg.”

The illustrative examples recognize and take into account that other types of carbon fiber include “dry fiber” which has not been impregnated with thermoset resin but may include a tackifier or binder. The illustrative examples recognize and take into account that dry fiber is infused with resin prior to hardening. The illustrative examples recognize and take into account that for thermoset resins, the hardening is a one-way process referred to as curing, while for thermoplastic resins, the resin reaches a viscous form if it is reheated, after which it can be consolidated to a desired shape and solidified. An umbrella term for the process of transitioning a preform to a final hardened shape (i.e., transitioning a preform into a composite part) can be referred to as “hardening, ” and this term encompasses both the curing of thermoset preforms and the forming/solidifying of thermoplastic preforms into a final desired shape. With this understanding in mind, further discussion focuses upon vacuum securement systems for compacting objects, such as preforms for composite parts, onto rigid tooling.

The illustrative examples provide high volume vacuum systems that quickly and effectively pick and place objects such as preforms onto complex surfaces, and that compact the objects into place via vacuum. The illustrative examples utilize two-phase vacuum systems which operate a first portion to generate a suction hold for carrying an object to tool, and operate a second portion to generate a suction hold that compacts the object onto tool. Compaction ensures that the object remains secured to tool, regardless of the orientation of tool.

The illustrative examples recognize and take into account that after placement using pick and place and compaction end effectors, the vacuum is shut off, but the retraction of the end effector away from the mandrel can work to facilitate a vacuum gripping. A vacuum gripping during retraction can pull the placed ply out of the desired location (shifting/disbonding). The illustrative examples provide a vacuum system end effector that enables a compacted stringer to stay in place better than the current stringer placement.

The illustrative examples recognize and take into account that leaks on the inside of an end effector from the first chamber to a second chamber can cause compaction on the outer impermeable membrane if the impermeable membrane is sufficiently large. In these cases, the end effector can compact when trying to pick up. The illustrative examples recognize and take into account that mitigating the leakage from the first chamber to the second chamber can reduce inadvertent compacting. The illustrative examples recognize and take into account that mitigating the leakage from the first chamber to the second chamber allows separation from the area generating negative pressure.

The illustrative examples provide an end effector that vents the vacuum directly to the atmosphere. By venting the vacuum directly to the atmosphere, this end effector sabotages the vacuum to permit the separation of the pick end effector from the material after placing and compaction.

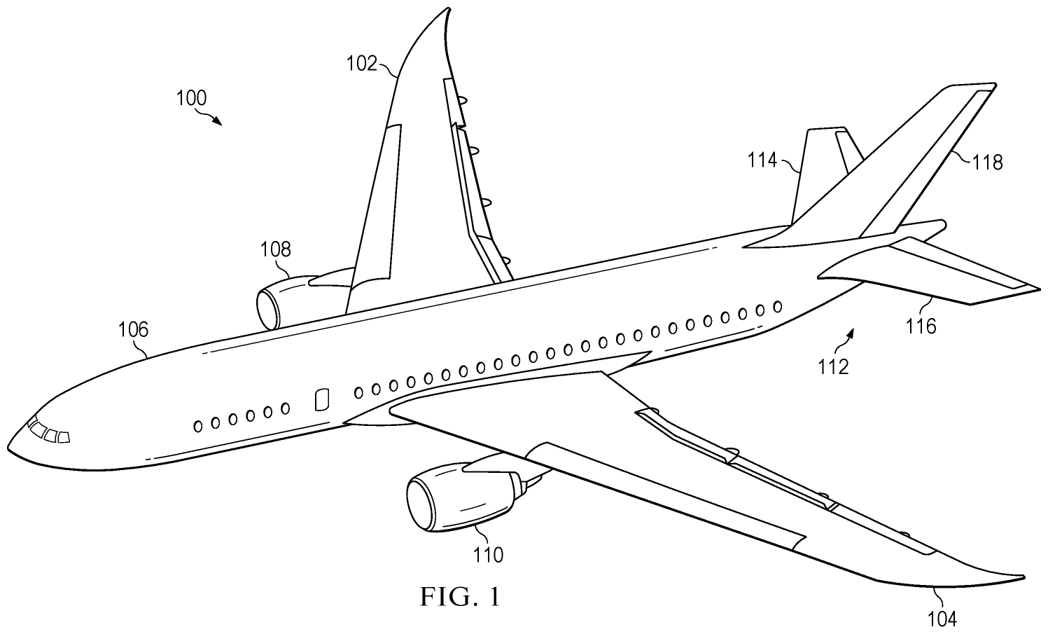

Turning now to FIG. 1, an illustration of an aircraft is depicted in accordance with an illustrative embodiment. Aircraft 100 has wing 102 and wing 104 attached to body 106. Aircraft 100 includes engine 108 attached to wing 102 and engine 110 attached to wing 104.

Body 106 has tail section 112. Horizontal stabilizer 114, horizontal stabilizer 116, and vertical stabilizer 118 are attached to tail section 112 of body 106.

Aircraft 100 is an example of an aircraft having composite parts that can be manufactured using a vacuum system end effector of the illustrative examples. A vacuum system end effector of the illustrative examples can be used to position and compact composite material for forming one of body 106, wing 102, or wing 104 of aircraft 100.

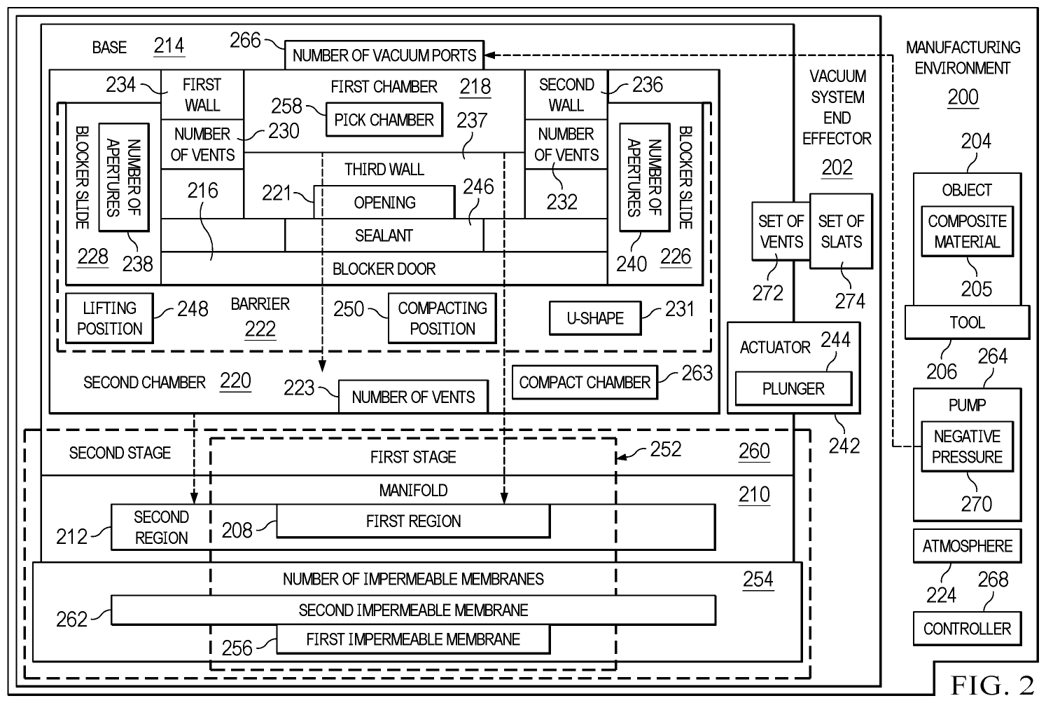

Turning now to FIG. 2, an illustration of a block diagram of a manufacturing environment is depicted in accordance with an illustrative embodiment. Manufacturing environment 200 has vacuum system end effector 202 configured to position and compact object 204 onto tool 206. In some illustrative examples, object 204 takes the form of composite material 205.

Vacuum system end effector 202 provides an improvement over prior pick and place end effectors.

Vacuum system end effector 202 provides for positioning composite material 205 without prematurely compacting composite material 205. Vacuum system end effector 202 also provides for removal of vacuum system end effector 202 from composite material 205 without undesirably shifting composite material 205.

Vacuum system end effector 202 comprises first region 208 of manifold 210 configured to pick up object 204, second region 212 of manifold 210 larger than first region 208 and configured to compress object 204, base 214, and blocker door 216. Base 214 comprises first chamber 218 configured to apply negative pressure 270 to first region 208, and second chamber 220 configured to apply negative pressure 270 to second region 212. Second chamber 220 comprises number of vents 223 to atmosphere 224; and

Blocker door 216 is configured to actuate to supply or block a supply of negative pressure 270 to second chamber 220. Opening 221 is present in first chamber 218 and configured to supply negative pressure 270 to second chamber 220. Blocker door 216 is moved towards and away opening 221 to control application of negative pressure 270 to second chamber 220. When blocker door 216 covers opening 221, blocker door 216 blocks negative pressure 270 from entering second chamber 220. When pulled away from opening 221, blocker door 216 allows negative pressure 270 to flow into second chamber 220.

In some illustrative examples, blocker door 216 is further configured to actuate to open or block number of vents 223 to atmosphere 224.

In some illustrative examples, blocker door 216 is part of barrier 222 that further comprises blocker slide 226 and blocker slide 228. In some illustrative examples, blocker door 216 is part of barrier 222. In some illustrative examples, barrier 222 comprises U-shape 231.

In some illustrative examples, second chamber 220 encompasses three sides of the first chamber 218. In these illustrative examples, a fourth wall of first chamber 218 also forms a fourth wall of second chamber 220. In other illustrative examples, second chamber 220 encompasses first chamber 218. In these illustrative examples, fourth wall of second chamber 220 surrounds first chamber 218.

In this illustrative example, number of vents 230 through the first chamber 218 configured to supply negative pressure 270 to second chamber 220. In this illustrative example, number of vents 230 is present in first wall 234 of first chamber 218, and opening 221 is present in third wall 237 of first chamber 218. Number of vents 230 provide greater flow of negative pressure 270 from first chamber 218 to second chamber 220.

In this illustrative example, number of vents 232 through the first chamber 218 configured to supply negative pressure 270 to second chamber 220. In this illustrative example, number of vents 232 is present in second wall 236 of first chamber 218, and opening 221 is present in third wall 237 of first chamber 218. Number of vents 232 provides greater flow of negative pressure 270 from first chamber 218 to second chamber 220.

Blocker door 216 is a portion of barrier 222, wherein barrier 222 further comprises number of apertures 238 in blocker slide 228 connected to blocker door 216, wherein number of apertures 238 is configured to move between blocking number of vents 230 through first chamber 218 and allowing flow through number of vents 230 through first chamber 218. Blocker door 216 is a portion of barrier 222, wherein barrier 222 further comprises number of apertures 240 in blocker slide 226 connected to blocker door 216, wherein number of apertures 240 are configured to move between blocking number of vents 232 through first chamber 218 and allowing flow through number of vents 232 through first chamber 218.

In some illustrative examples, barrier 222 is connected to plunger 244 to move barrier 222 within second chamber 220 relative to first chamber 218. Plunger 244 is configured to move barrier 222 against atmosphere 224 pressing barrier 222 towards opening 221. In some illustrative examples, sealant 246 is present around opening 221 to seal blocker door 216 against third wall 237 to block opening 221.

When negative pressure 270 is supplied to first chamber 218 for picking up object 204, barrier 222 is in lifting position 248. In lifting position 248, blocker door 216 blocks opening 221. In lifting position 248, barrier 222 blocks number of vents 230 and number of vents 232. In lifting position 248, second chamber 220 is vented to atmosphere 224 through number of vents 223. In some illustrative examples, first chamber 218 is referred to as pick chamber 258. When negative pressure 270 is present in first chamber 218 and barrier 222 is in lifting position 248, negative pressure 270 is supplied to first stage 252. With barrier 222 in lifting position 248, negative pressure 270 is supplied to first region 208 of manifold 210 and beneath first impermeable membrane 256 to lift object 204 and place object 204 onto tool 206.

To supply negative pressure 270 to second chamber 220, barrier 222 is placed in compacting position 250. In compacting position 250, negative pressure 270 is supplied to second chamber 220 through opening 221, number of vents 230 when present, and number of vents 232 when present. In compacting position 250, number of apertures 238 are positioned to allow negative pressure 270 through number of vents 230. In compacting position 250, number of apertures 240 are positioned to allow negative pressure 270 through number of vents 232.

In some illustrative examples, second chamber

220 is referred to as compact chamber 263. When negative pressure 270 is present in first chamber 218 and second chamber 220 and barrier 222 is in compacting position 250 and blocks number of vents 223. With barrier 222 in compact chamber 263, negative pressure 270 is supplied to first region 208 and second region 212 of manifold 210. When negative pressure 270 is supplied to first region 208 and second region 212 of manifold 210, negative pressure 270 is supplied beneath first impermeable membrane 256 and second impermeable membrane 262 to compact object 204 on tool 206.

Number of impermeable membranes 254 is impermeable to gas, and may comprise at least one of plastic or rubberized sheet. Number of impermeable membranes 254 is not glued or attached to object 204, but rather rests atop object 204. When a vacuum is applied to an impermeable membrane of number of impermeable membranes 254 (e.g., via one or more holes within an interior of the respective impermeable membrane) , the borders of the impermeable membrane will form a suction hold against object 204, when more air is being drawn out than is capable of entering via any leaks between object 204 and the respective impermeable membrane at the border of the impermeable membrane.

Vacuum system end effector 202 is disposed proximate to object 204. In some illustrative examples, this comprises operating vacuum system end effector 202 in accordance with a Numerical Control (NC) program. Object 204 is covered with number of impermeable membranes 254. In one embodiment, first impermeable membrane 256 of number of impermeable membranes 254 is smaller than object 204 while second impermeable membrane 262 of number of impermeable membranes 254 is larger than object 204.

In some illustrative examples, it can be said that first impermeable membrane 256 is surrounded by object 204, while second impermeable membrane 262 surrounds object 204. When first impermeable membrane 256 is within the bounds of object 204, first impermeable membrane 256 is therefore capable of applying suction directly to object 204. Second impermeable membrane 262 extends beyond the bounds of object 204, and second impermeable membrane 262 therefore is capable of applying suction to an area that surrounds object 204. Applying suction to an area that surround object 204 has the effect of drawing second impermeable membrane 262 against the area that surrounds object 204. Drawing second impermeable membrane 262 against the area compacts object 204.

To pick up object 204, vacuum system end effector 202 applies negative pressure 270 sufficient to offset/overcome any air leaks between first impermeable membrane 256 and object 204. When negative pressure 270 is applied, the borders of first impermeable membrane 256 are drawn into suction contact with object 204, because as air is removed, the borders of first impermeable membrane 256 are brought into contact with object 204. Applying negative pressure 270 beneath first impermeable membrane 256 forms a suction hold that secures object 204 to first impermeable membrane 256, regardless of air leaks that might occur between first impermeable membrane 256 and object 204.

Vacuum system end effector 202 can transport object 204 to tool 206 while the suction hold is retained. After applying object 204 to tool 206, vacuum system end effector 202 applies negative pressure 270 to compact object 204 to tool 206. After applying object 204 to tool 206, vacuum system end effector 202 applies negative pressure 270 sufficient to offset any air leaks between second impermeable membrane 262 and tool 206. Applying negative pressure 270 sufficient to offset any air leaks between second impermeable membrane 262 and tool 206 forms a suction hold that secures object 204 to tool 206.

When negative pressure 270 is applied, second impermeable membrane 262 applies suction that pulls second impermeable membrane 262 towards tool 206. This suction compacts object 204 into place at tool 206. When a tackifier is present, compacting object 204 into place at tool 206 can activate the tackifier via pressure.

After compaction has been completed, vacuum system end effector 202 stops applying negative pressure 270, and the suction hold applied to object 204 and tool 206 is released. Release of the suction is aided by number of vents 223 in second chamber 220. Number of vents 223 allow for release of the compaction force so that object 204 remains on tool 206.

When applying suction to grip object 204, pump 264 applies suction by removing a higher volume of air than is lost via gaps between first stage 252 and object 204. This means first stage 252 does not need to be sealed via tape, sealant, or other materials to object 204 being transported. Instead, vacuum system end effector 202 is capable of relying on negative pressure 270 applied by pump 264 in order to perform picking and placing of object 204.

When applying negative pressure 270 to compact object 204 to tool 206, the pump 264 provides sufficient volumetric flow to offset air leaks between second stage 260 and tool 206. This means that second stage 260 does not need to be sealed via tape, sealant, or other materials to tool 206. Instead, vacuum system end effector 202 is capable of relying on negative pressure 270 applied by pump 264 in order to perform compaction. Controller 268 manages the operations of the pump 264, actuator 242, and vacuum system end effector 202 in accordance with an NC program stored in memory. Controller 268 may be implemented, for example, as custom circuitry, as a hardware processor executing programmed instructions, or some combination thereof.

Controller 268 manages the operations of pump 264. For example, controller 268 may adjust the amount of power applied to pump 264 in order to ensure a constant level of pressure or airflow, or to selectively control application of negative pressure 270 to first region 208 and/or second region 212. When negative pressure 270 is applied, air being drawn out by pump 264 is sufficient to offset air incursion along the perimeter of first impermeable membrane 256 due to loss of vacuum. This maintains a desired level of vacuum under the first impermeable membrane 256.

FIG. 2 illustrates a base 214 of vacuum system end effector 202 that applies negative pressure 270 via multiple stages in an illustrative example. In this illustrative example, base 214 includes integral components for selectively applying negative pressure 270 to first stage 252 and second stage 260 of manifold 210.

Base 214 is coupled to a manifold 210 for distributing negative pressure 270 across an area. The interior of base 214 includes first chamber 218 for applying negative pressure 270 to first stage 252, and second chamber 220 for applying negative pressure 270 to second stage 260. Barrier 222 moves within base 214 to selectively expose opening 221 between first chamber 218 (that applies negative pressure 270 via first stage 252 to a first portion) and the second chamber 220 (that applies negative pressure 270 via second stage 260 to a second portion). In this manner, negative pressure 270 from number of vacuum ports 266 is controllably applied to first chamber 218, or to both first chamber 218 and second chamber 220.

The configuration of base 214 provides a technical benefit over prior systems, because it enables greater control of application to and removal of negative pressure 270 from second chamber 220. Number of vents 223 prevents leakage of negative pressure 270 from second chamber 220 into second region 212 of manifold 210 during lifting and placement of object 204. Number of vents 223 can reduce or prevent unintended compaction of object 204. Number of vents 223 enables venting of negative pressure 270 from second chamber 220 after compaction. Number of vents 223 reduces or prevents pulling of object 204 from tool 206 when vacuum system end effector 202 is pulled from object 204. This reduces and/or eliminates associated rework.

The illustration of manufacturing environment 200 in FIG. 2 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, although not depicted in FIG. 2, permeable membranes can be present to distribute negative pressure 270 within first stage 252 and second stage 260. In one illustrative example, a first permeable membrane can be present to distribute negative pressure 270 within first stage 252. In one illustrative examples, a second permeable membrane can be present to distribute negative pressure 270 within second stage 260.

As another example, optional components are depicted in FIG. 2. Optional components depicted in

FIG. 2 include set of vents 272 through second chamber 220 to atmosphere 224. A set of items includes one of more items. Accordingly, set of vents 272 includes one or more vents. Additional optional components include set of slats 274. Set of slats 274 is associated with set of vents 272 to actuate between blocking set of vents 272 or allowing communication between second chamber 220 and atmosphere 224.

Set of slats 274 is actuated to move from allowing communication between set of vents 272 through second chamber 220 and atmosphere 224 to blocking set of vents 272. Set of vents 272 is separate from number of vents 223 through second chamber 220.

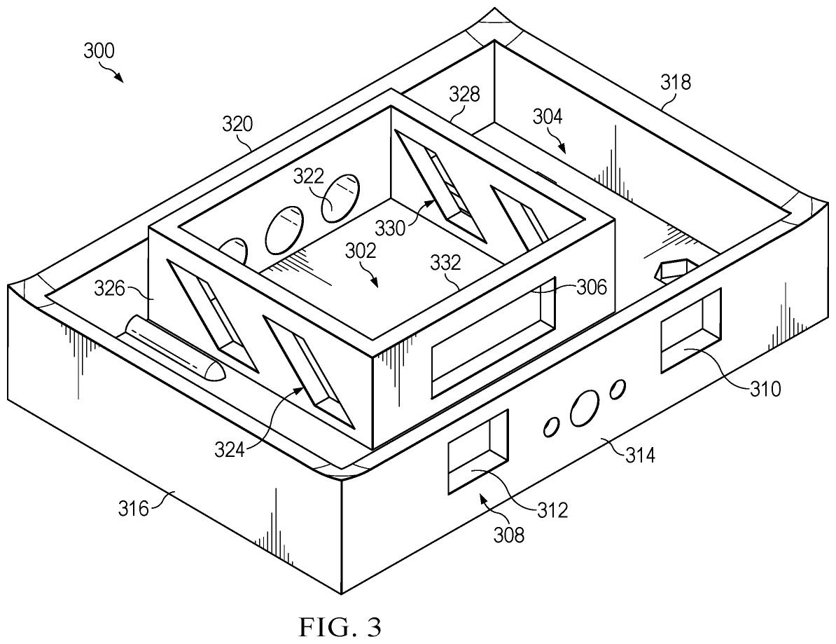

Turning now to FIG. 3, an illustration of an isometric view of a base of a vacuum system end effector is depicted in accordance with an illustrative embodiment. Base 300 is a physical implementation of base 214 of FIG. 2.

Base 300 is configured to control negative pressure supplied to a first region of a manifold and a second region of the manifold of a vacuum system end effector. Base 300 comprises first chamber 302 and second chamber 304. Opening 306 extending through first chamber 302 is configured to supply negative pressure to second chamber 304. Number of vents 308 extends through second chamber 304 to the atmosphere outside base 300. As depicted, number of vents 308 includes vent 310 and vent 312. Number of vents 308 is configured to overcome any leakage from first chamber 302. A quantity and size of vents in number of vents 308 are configured to overcome leakage of vacuum from first chamber 302.

In this illustrative example, number of vents 308 includes two vents on a same face of second chamber 304. In other illustrative examples, more than two vents can be present through second chamber 304. As depicted, number of vents 308 extend through first wall 314 of second chamber 304. In some illustrative examples, at least one vent may be present through at least one of second wall 316 or third wall 318 of second chamber 304. In some illustrative examples, a set of vents (not depicted) extend through second chamber 304 separately from number of vents 308. As used herein, a set of items is one or more items. In some illustrative examples, a set of vents (not depicted) extends through second wall 316. In some illustrative examples, a set of vents (not depicted) extends through third wall 318.

In some illustrative examples, a set of slats (not depicted) is provided on the exterior of second chamber 304 to move from allowing communication between a set of vents through second chamber 304 and the atmosphere to blocking the set of vents. In some illustrative examples, a different method of actuating between communication with the atmosphere and blocking the set of vents is provided.

As depicted, first chamber 302 is positioned within second chamber 304. In this illustrative example, first chamber 302 is rectangular. In this illustrative example, second chamber 304 surrounds and encompasses at least three walls of first chamber 302. In this illustrative example, second chamber 304 is rectangular and encompasses a “box” forming first chamber 302. In some non-depicted illustrative examples, first chamber 302 and second chamber 304 can share a wall.

As depicted, first wall 314, second wall 316, and third wall 318 of second chamber 304 form an exterior of base 300 with fourth wall 320. Ports 322 are present in fourth wall 320 to provide negative pressure to first chamber 302 of base 300.

As depicted, number of vents 324 and number of vents 330 extend through first chamber 302. Number of vents 324 includes vents through first wall 326 of first chamber 302. Number of vents 330 includes vents through second wall 328 of first chamber 302. Opening 306 extends through third wall 332 of first chamber 302. Number of vents 324 and number of vents 330 can be optional. Number of vents 324 and number of vents 330 increase the flow of negative pressure from first chamber 302 to second chamber 304.

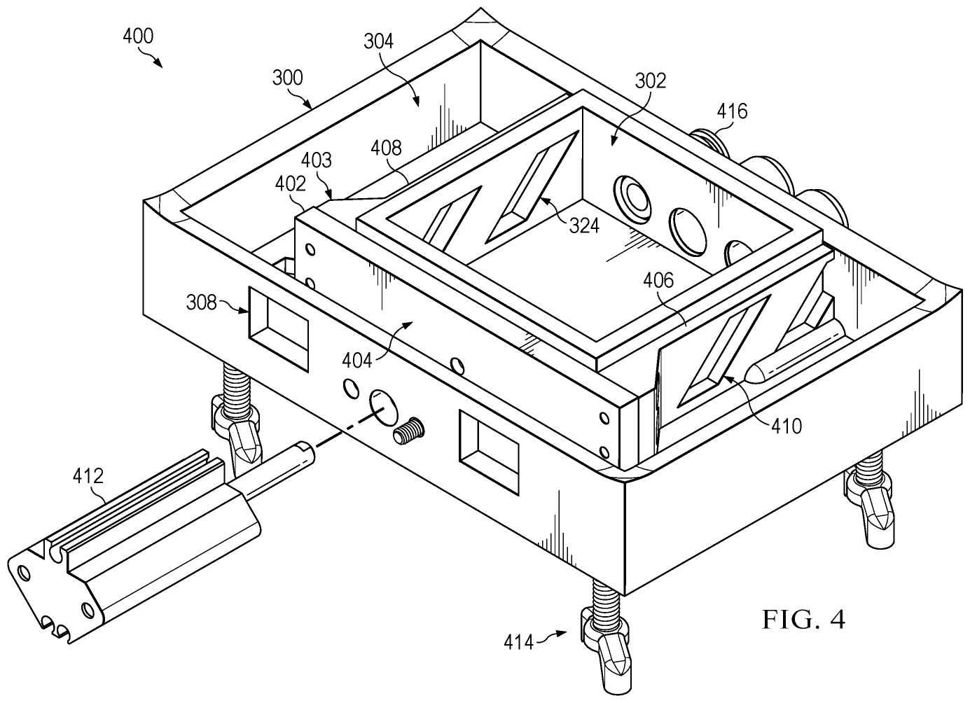

Turning now to FIG. 4, an illustration of a portion of a vacuum system end effector in a lifting position is depicted in accordance with an illustrative embodiment. In view 400, additional operating components are present within base 300. As depicted, barrier 402 is present within base 300. Barrier 402 is configured to control application of negative pressure to second chamber 304 of base 300. As depicted, barrier 402 is in lifting position 403. In lifting position, barrier 402 blocks opening 306 of FIG. 3. More specifically, blocker door 404 of barrier 402 covers opening 306 of FIG. 3. In this illustrative example, barrier 402 further comprises blocker slide 406 and blocker slide 408. Blocker slide 406 and blocker slide 408 are configured to actuate between blocking number of vents 324 and number of vents 330 or allowing a supply of negative pressure through number of vents 324 and number of vents 330 (not visible) to second chamber 304.

In this illustrative example, base 300 comprises number of vents 330 through first chamber 302 and barrier 402 comprises number of apertures 410. Barrier 402 is configured to actuate between blocking number of vents 330 or allowing a supply of negative pressure through number of vents 330 to second chamber 304.

In this illustrative example, barrier 402 comprises blocker door 404 configured to block opening 306 or number of vents 308 and blocker slide 406 connected to blocker door 404. Blocker slide 406 comprises number of apertures 410 configured to provide negative pressure into second chamber 304 through number of vents 330. In this illustrative example, blocker slide 406 is configured to block number of vents 330 in second wall 328 of first chamber 302.

Barrier 402 also comprises blocker slide 408. Blocker slide 408 has a set of apertures (not visible). The set of apertures of blocker slide 408 is configured to provide negative pressure into second chamber 304 through number of vents 324.

Actuator 412 is connected to barrier 402. Actuator 412 is actuated to move barrier 402 within second chamber 304. Barrier 402 is connected to actuator 412 to move barrier 402 within second chamber 304 relative to first chamber 302. By moving barrier 402 within second chamber 304, negative pressure can be applied or blocked to second chamber 304.

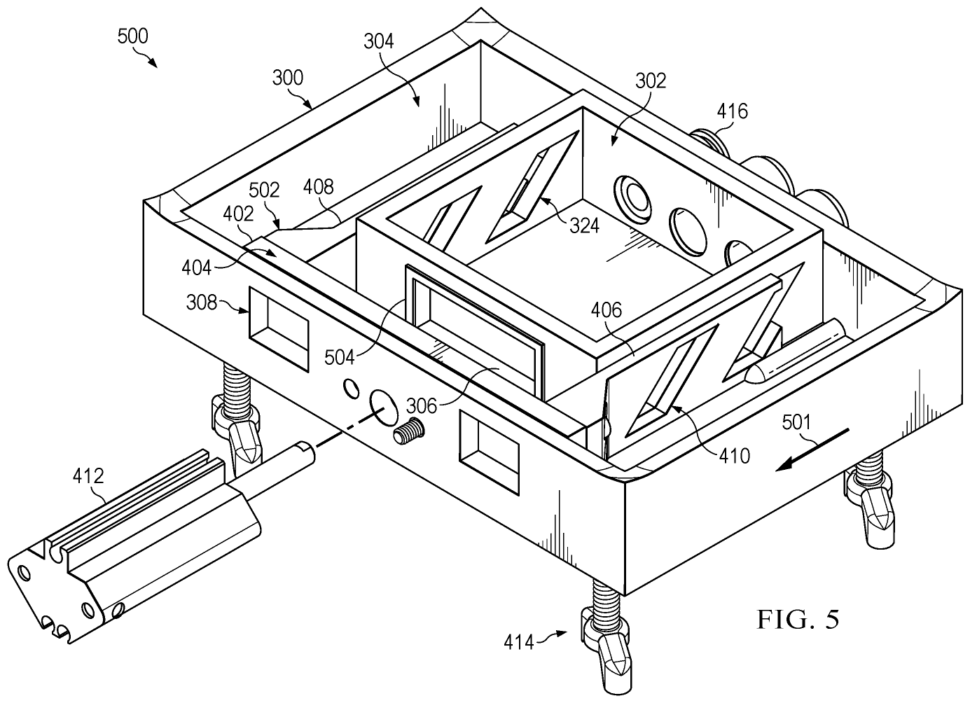

Turning now to FIG. 5, an illustration of a portion of a vacuum system end effector in a compacting position is depicted in accordance with an illustrative embodiment. In view 500, actuator 412 has been actuated to pull barrier 402 in direction 501. In view 500, barrier 402 is in compacting position 502. In view 500, actuator 412 has been actuated to pull barrier 402 towards number of vents 308 in second chamber. In view 500, actuator 412 has been actuated to pull barrier 402 away from opening 306 in first chamber 302.

When barrier 402 is in compacting position 502, blocker door 404 of barrier 402 blocks number of vents 308. By blocking number of vents 308, leaks of negative pressure are reduced from second chamber 304.

When barrier 402 is in compacting position 502, blocker door 404 of barrier 402 has been moved to allow negative pressure to flow from first chamber 302 through opening 306 into second chamber 304. In this illustrative example, when barrier 402 is in compacting position 502, plurality of apertures 410 have been slid relative to first chamber 302 to allow negative pressure to flow through number of vents 330. In this illustrative example, when barrier 402 is in compacting position 502, plurality of apertures (not visible) in blocker slide 408 have been slid relative to first chamber 302 to allow negative pressure to flow through number of vents 324.

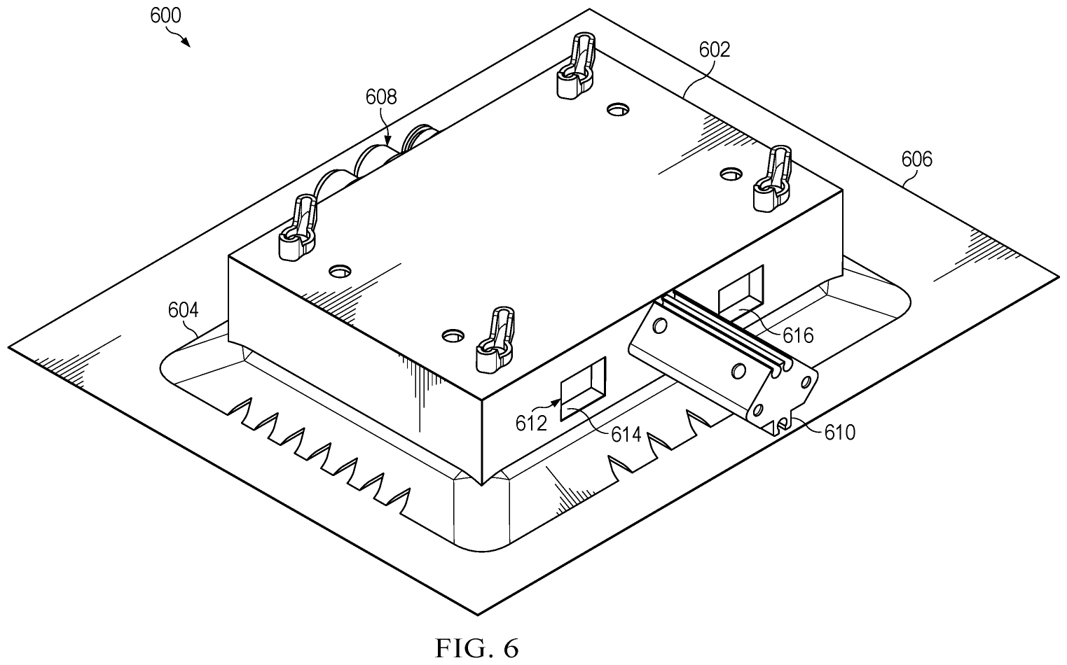

Turning now to FIG. 6, an illustration of an isometric view of a vacuum system end effector is depicted in accordance with an illustrative embodiment. Vacuum system end effector 600 is a physical implementation of vacuum system end effector 202 of FIG. 2. In some illustrative examples, base 602 can be the same as base 300 of FIGS. 3-5.

Vacuum system end effector 600 comprises base 602, manifold 604, and second stage impermeable membrane 606. negative pressure is supplied to base 602 by ports 608. Base 602 directs negative pressure to manifold 604. Base 602 is controlled to direct negative pressure to at least one of a first region of manifold 604 or a second region of manifold 604. Operation of base 602 controls whether vacuum system end effector 600 lifts or compresses an object.

Actuator 610 is connected to a barrier (not depicted) within base 602. Actuator 610 takes the form of a plunger. Actuator 610 moves the barrier within base 602 to allow or block negative pressure within a second chamber in base 602 to compress an object. Actuator 610 moves the barrier within base 602 to open or block number of vents 612 in a second chamber of base 602. Number of vents 612 includes vent 614 and vent 616.

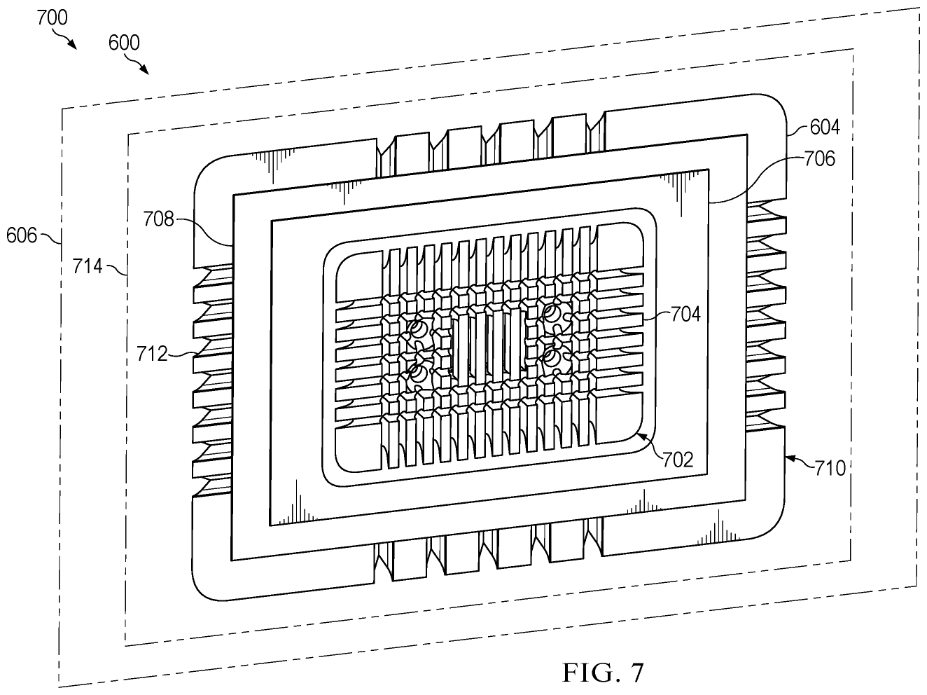

Turning now to FIG. 7, an illustration of a bottom view of a vacuum system end effector is depicted in accordance with an illustrative embodiment. View 700 is a bottom perspective view of vacuum system end effector 600 of FIG. 6. In view 700, base 602 is not visible. In view 700, first region 702 of manifold 604 is shown. First region 702 of manifold 604 is configured to provide negative pressure to lift an object, such as a composite material. First stage passages 704 of first region 702 direct negative pressure to first stage permeable membrane 706. First stage impermeable membrane 708 forms a pressure seal for first region 702 of manifold 604. Second region 710 of manifold 604 is configured to provide negative pressure to compress an object. Second stage passages 712 of second region 710 direct negative pressure to second stage permeable membrane 714. Second stage impermeable membrane 606 forms a pressure seal.

A first chamber (not depicted) of base 602 of FIG. 6 provides negative pressure to first region 702 of manifold 604. A second chamber (not depicted) of base 602 of FIG. 6 provides negative pressure to second region 710 of manifold 604.

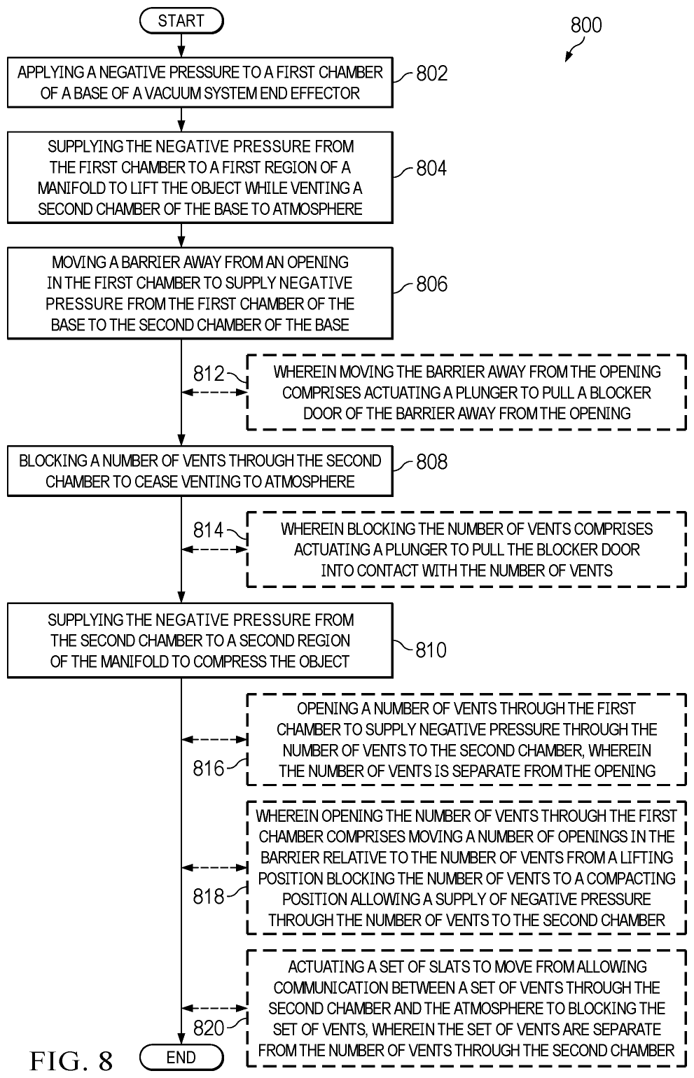

Turning now to FIG. 8, a flowchart of method of picking and placing an object is depicted in accordance with an illustrative embodiment. Method 800 can be performed to form a portion of aircraft 100. For example, method 800 can be performed to form part of body 106 of aircraft 100. Method 800 can be performed using vacuum system end effector 202 of FIG. 2. Method 800 can be performed using a vacuum system end effector having base 300 of FIGS. 3-5. Method 800 can be performed using vacuum system end effector 600 of FIGS. 6-7.

Method 800 applies a negative pressure to a first chamber of a base of a vacuum system end effector (operation 802). Method 800 supplies the negative pressure from the first chamber to a first region of a manifold to lift the object while venting a second chamber of the base to atmosphere (operation 804). Method 800 moves a barrier away from an opening in the first chamber to supply negative pressure from the first chamber of the base to the second chamber of the base (operation 806). Method 800 blocks a number of vents through the second chamber to cease venting to atmosphere (operation 808). Method 800 supplies the negative pressure from the second chamber to a second region of the manifold to compress the object (operation 810). Afterwards, method 800 terminates.

In some illustrative examples, moving the barrier away from the opening comprises actuating a plunger to pull a blocker door of the barrier away from the opening (operation 812). To move the barrier away from the opening, the plunger needs to pull the blocker door sufficiently to overcome the atmospheric force.

In some illustrative examples, blocking the number of vents comprises actuating a plunger to pull the blocker door into contact with the number of vents (operation 814). To block the number of vents, the plunger needs to pull the blocker door sufficiently to overcome the atmospheric force.

In some illustrative examples, method 800 opens a number of vents through the first chamber to supply negative pressure through the number of vents to the second chamber, wherein the number of vents is separate from the opening (operation 816). In some illustrative examples, the number of vents is in a different wall of the first chamber than the opening.

In some illustrative examples, opening the number of vents through the first chamber comprises moving a number of apertures in the barrier relative to the number of vents from a lifting position blocking the number of vents to a compacting position allowing a supply of negative pressure through the number of vents to the second chamber (operation 818). In some illustrative examples, movement of the barrier towards the number of vents in the second chamber also opens the number of vents.

In some illustrative examples, a set of vents is also present in the second chamber to provide additional venting to atmosphere. In some illustrative examples, the set of vents is actuated to prevent or allow communication between the second chamber and the atmosphere. In some illustrative examples, method 800 actuates a set of slats to move from allowing communication between a set of vents through the second chamber and the atmosphere to blocking the set of vents, wherein the set of vents are separate from the number of vents through the second chamber (operation 820).

As used herein, the phrase “at least one of,” when used with a list of items, means different combinations of one or more of the listed items may be used and only one of each item in the list may be needed. For example, “at least one of item A, item B, or item C” may include, without limitation, item A, item A and item B, or item B. This example also may include item A, item B, and item C or item B and item C. Of course, any combinations of these items may be present. In other examples, “at least one of” may be, for example, without limitation, two of item A; one of item B; and ten of item C; four of item B and seven of item C; or other suitable combinations. The item may be a particular object, thing, or a category. In other words, at least one of means any combination items and number of items may be used from the list but not all of the items in the list are required.

As used herein, “a number of, ” when used with reference to items means one or more items.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step.

In some alternative implementations of an illustrative embodiment, the function or functions noted in the blocks may occur out of the order noted in the figures. For example, in some cases, two blocks shown in succession may be executed substantially concurrently, or the blocks may sometimes be performed in the reverse order, depending upon the functionality involved. Also, other blocks may be added in addition to the illustrated blocks in a flowchart or block diagram. Some blocks may be optional. For example, operation 812 through operation 820 may be optional.

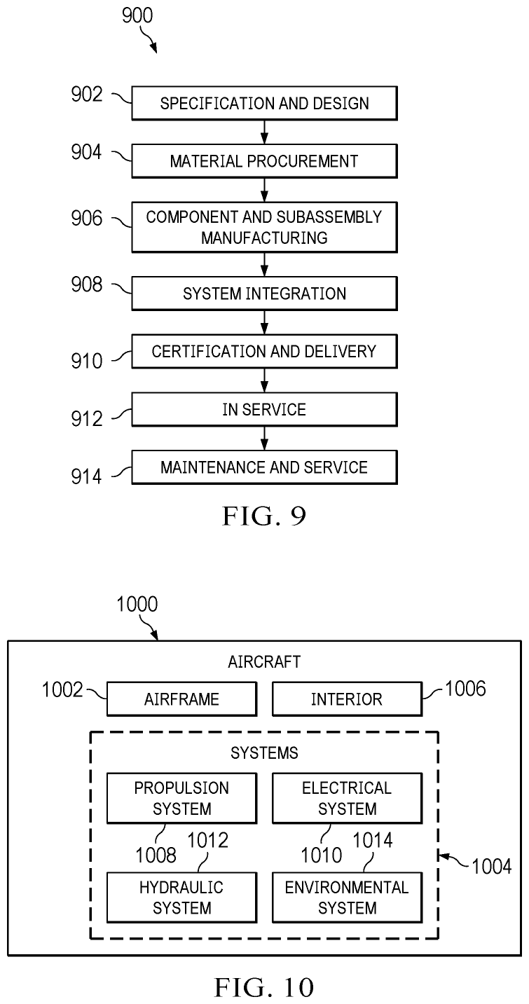

Illustrative embodiments of the present disclosure may be described in the context of aircraft manufacturing and service method 900 as shown in FIG. 9 and aircraft 1000 as shown in FIG. 10. Turning first to FIG. 9, an illustration of an aircraft manufacturing and service method in a form of a block diagram is depicted in accordance with an illustrative embodiment. During pre-production, aircraft manufacturing and service method 900 may include specification and design 902 of aircraft 1000 in FIG. 10 and material procurement 904.

During production, component and subassembly manufacturing 906 and system integration 908 of aircraft 1000 takes place. Thereafter, aircraft 1000 may go through certification and delivery 910 in order to be placed in service 912. While in service 912 by a customer, aircraft 1000 is scheduled for routine maintenance and service 914, which may include modification, reconfiguration, refurbishment, or other maintenance and service.

Each of the processes of aircraft manufacturing and service method 900 may be performed or carried out by a system integrator, a third party, and/or an operator. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 10, an illustration of an aircraft in a form of a block diagram is depicted in which an illustrative embodiment may be implemented. In this example, aircraft 1000 is produced by aircraft manufacturing and service method 900 of FIG. 9 and may include airframe 1002 with plurality of systems 1004 and interior 1006. Examples of systems 1004 include one or more of propulsion system 1008, electrical system 1010, hydraulic system 1012, and environmental system 1014. Any number of other systems may be included.

Apparatuses and methods embodied herein may be employed during at least one of the stages of aircraft manufacturing and service method 900. One or more illustrative embodiments may be manufactured or used during at least one of component and subassembly manufacturing 906, system integration 908, in service 912, or maintenance and service 914 of FIG. 9.

A portion of airframe 1002 or interior 1006 of aircraft 1000 can be formed by method 800. Method 800 can be performed during component and subassembly manufacturing 906. A structure with a sealant, adhesive, or other viscous material deposited using method 800 can be present and utilized during in service 912. Method 800 can be performed during maintenance and service 914 to form a replacement part.

The illustrative examples provide a vacuum system end effector with improved pick and place and compression capabilities. The configuration of the base of the illustrative examples provides a technical benefit over prior systems, because it enables greater control of application to and removal of negative pressure from a compaction chamber of the base. A number of vents in the second chamber prevents leakage of negative pressure from second chamber into a second region of a manifold during lifting and placement of an object. The number of vents can reduce or prevent unintended compaction of the object. The number of vents enables venting of negative pressure from the second chamber after compaction as well. The number of vents reduces or prevents pulling of the object from the tool when the vacuum system end effector is pulled from the object. This reduces and/or eliminates associated rework.

The description of the different illustrative embodiments has been presented for purposes of illustration and description, and is not intended to be exhaustive or limited to the embodiments in the form disclosed. Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A vacuum system end effector comprising:
a first region of a manifold configured to pick up an object;
a second region of the manifold larger than the first region and configured to compress the object;
a base comprising:
a first chamber configured to apply negative pressure to the first region; and
a second chamber configured to apply negative pressure to the second region, the second chamber comprising a number of vents to atmosphere; and
a blocker door configured to actuate to supply or block a supply of negative pressure to the second chamber.

2. The vacuum system end effector of claim 1, wherein the second chamber encompasses three sides of the first chamber.

3. The vacuum system end effector of claim 1 further comprising:
an opening in the first chamber configured to supply negative pressure to the second chamber.

4. The vacuum system end effector of claim 3 further comprising:
a number of vents through the first chamber configured to supply negative pressure to the second chamber.

5. The vacuum system end effector of claim 4, wherein the number of vents is present in a first wall of the first chamber, and wherein the opening is present in a third wall of the first chamber.

6. The vacuum system end effector of claim 4, wherein the blocker door is part of a barrier, the barrier comprising a U-shape.

7. The vacuum system end effector of claim 4, wherein the blocker door is a portion of a barrier, wherein the barrier further comprises a number of apertures in a blocker slide connected to the blocker door, wherein the number of apertures is configured to move between blocking the number of vents through the first chamber and allowing flow through the number of vents through the first chamber.

8. The vacuum system end effector of claim 7, wherein the barrier is connected to a plunger to move the barrier within the second chamber relative to the first chamber.

9. The vacuum system end effector of claim 1, wherein the blocker door is further configured to actuate to open or block the number of vents to atmosphere.

10. A vacuum system end effector comprising:
a base configured to control negative pressure supplied to a first region of a manifold and a second region of the manifold, the base comprising:
a first chamber configured to provide negative pressure to the first region of the manifold;
a second chamber configured to provide negative pressure to the second region of the manifold;
an opening through the first chamber configured to supply negative pressure to the second chamber; and
a vent through the second chamber to atmosphere; and
a barrier configured to actuate between blocking the opening or blocking the vent.

11. The vacuum system end effector of claim 10 further comprising:
a number of vents through the first chamber; and
a number of apertures in the barrier configured to actuate between blocking the number of vents or allowing a supply of negative pressure through the number of vents to the second chamber.

12. The vacuum system end effector of claim 11, wherein the barrier comprises a blocker door configured to block the opening or the vent and a blocker slide connected to the blocker door, the blocker slide comprising the number of apertures configured to block the number of vents.

13. The vacuum system end effector of claim 10 further comprising:
a set of vents through the second chamber to atmosphere; and
a set of slats associated with the set of vents to actuate between blocking the set of vents or allowing communication between the second chamber and the atmosphere.

14. The vacuum system end effector of claim 10 further comprising:
the first region of the manifold configured to pick up an object; and
the second region of the manifold larger than the first region and configured to compress the object.

15. The vacuum system end effector of claim 10, wherein the barrier is connected to a plunger to move the barrier within the second chamber relative to the first chamber.

16. A method of picking and placing an object, the method comprising:
applying a negative pressure to a first chamber of a base of a vacuum system end effector;
supplying the negative pressure from the first chamber to a first region of a manifold to lift the object while venting a second chamber of the base to atmosphere;
moving a barrier away from an opening in the first chamber to supply negative pressure from the first chamber of the base to the second chamber of the base;
blocking a number of vents through the second chamber to cease venting to atmosphere; and
supplying the negative pressure from the second chamber to a second region of the manifold to compress the object.

17. The method of claim 16, wherein moving the barrier away from the opening comprises actuating a plunger to pull a blocker door of the barrier away from the opening.

18. The method of claim 17, wherein blocking the number of vents comprises actuating a plunger to pull the blocker door into contact with the number of vents.

19. The method of claim 16 further comprising:
opening a number of vents through the first chamber to supply negative pressure through the number of vents to the second chamber, wherein the number of vents is separate from the opening.

20. The method of claim 19, wherein opening the number of vents through the first chamber comprises moving a number of apertures in the barrier relative to the number of vents from a lifting position blocking the number of vents to a compacting position allowing a supply of negative pressure through the number of vents to the second chamber.

21. The method of claim 16 further comprising:
actuating a set of slats to move from allowing communication between a set of vents through the second chamber and the atmosphere to blocking the set of vents, wherein the set of vents are separate from the number of vents through the second chamber.
